(19) United States
(12) Patent Application Publication
(10) Pub. No.: US 2005/0061777 A1
(43) Pub. Date: Mar. 24, 2005

(54) Resistance welding system

(76) Inventors: Eckart Goetz, Erbach (DE); Dieter Stellwag, Erbach (DE); Heinz-Ullrich Mueller, Michelstadt (DE); Reinhard Scholz, Erbach (DE)

Correspondence Address: STRIKER, STRIKER & STENBY, 103 EAST NECK ROAD, HUNTINGTON, NY, 17743, US

(21) Appl. No.: 10/936,194

(22) Filed: Sep. 8, 2004

(30) Foreign Application Priority Data
Sep. 8, 2003 (DE) 103 41 673.0

(51) Int. Cl. B23K 11/24

(52) U.S. Cl. 219/108

(57) ABSTRACT

An apparatus for resistance welding with a welding system has an energy supply system, a welding convertor, a welding process control, a servowelding tong, a servotong control, wherein the welding convertor, the welding process control, the energy supply system and the servotong control form a structural unit.

### BACKGROUND OF THE INVENTION

The present invention relates to a welding convertor for resistance welding.

Resistance welding systems are irreplaceable for the modern manufacture and are often combined with robots to automate the manufacturing lines, for example for welding together the components of autobodies.

Modern resistance welding systems use welding tongs which are operated by servomotors instead of pneumatic drives. Thereby a high accuracy of the positioning (position regulation) and a fast buildup of the pressing force can be provided. Compared with the pneumatic system, a servotong requires however a complex control system. This resistance welding system as a rule is composed of a power unit, a welding convertor, a welding transformer, one or several servowelding tong (tongs), one or several servotong control element (elements) and a welding control unit. The servotong control element includes a drive convertor and a servomotor control system, which is necessary for controlling a servomotor-operated welding tong (servowelding tong).

The welding process is controlled directly by the welding control unit, wherein the strength of the welding connection depends substantially on the force of the servotong and the quality of the current regulation.

Current systems which were designed conventionally for welding tongs with a pneumatic drive are constructed of individual components and do not correspond to the increased communication demands of the servotongs, or are not in the position to use all advantages, for example speed of the force build up of a servotong. During the welding process also intense electromagnetic fields are generated, which can interfere with a communication system having a high band width. The quality on the welding therefore can fluctuate and the system is not used in an optimal fashion.

There are two conventional system variants. In the first variant the two additional servodrive units, such as the drive convertor, are integrated in the robot. The disadvantage of this variant is the slow communication to external welding process-related welding control unit. In the second variant, the tool drive units are accommodated in an additional switching cabinet with the power source and various communication interfaces, and connected with an optional SPS. This system includes a data exchange both to a robot, as well as to the welding control unit and represents an expensive solution.

### SUMMARY OF THE INVENTION

Accordingly, it is an object of the present invention to provide a welding system for resistance welding, which eliminates the disadvantages of the prior art.

More particularly it is an object of the present invention to provide a welding system for resistant welding, which has a simple construction and provides a fast communication to the components, so that the system is dynamically optimized and the welding quality is increased.

In keeping with these objects and with others which will become apparent hereinafter, one feature of the present invention resides, briefly stated in an apparatus for resistance welding with a welding system, comprising an energy supply system; a welding convertor; a welding process control; a servowelding tong; a servotong control; said welding convertor, said welding process control, said energy supply system and said servotong control forming a structural unit.

An important feature of the present invention is that the servotong control unit, the welding convertor, the energy supply system and the welding process control unit form together a structural unit. The advantages of the inventive approach is reduced mounting expense, reduced cost and reduction of the complexity and interference sensitivity of the communication system.

The communication between the servotong, the servotong control unit and the welding control unit is optimal, and the communication between the welding and the servotong control unit is performed in a stabile electromagnetic surrounding, the cable expense is minimized or completely dispensed with, and can be optimized for the welding process. The above mentioned advantages are indispensable for an online real-time regulation system.

Advantageously, the welding convertor, and the at least one servotong control unit are supplied with energy from a common power unit. The system architecture reduces the number of the required power electronic components, such as for example a rectifier, elko's, throttles, to a minimum, since only one power unit is available. These components are expensive to purchase and because of their high temperature operation have a short MTBF (Mean Time Between Failures), that determine MTBF for such systems. A reduction of the sensitive components correspondingly results in an increase of the MTBF.

A further advantage of the invention resides in that for the energy supply of the logic circuit of the welding convertor, the welding process control unit and the servotong control unit is provided with only one power unit. This system architecture reduces the number of the required logic supply components to a minimum, since only one power unit is available.

Another advantage of the present invention is provided since a joint cooling system is utilized for the heat withdrawal of the welding rectifier and the servotong control unit. This leads to a simplification of the mechanics and a minimization of the structural volume.

Another advantage of the present invention is that the data exchange is very fast and reliable between the welding process control unit and the servotong control unit through a shared memory. The welding process control unit can make available all data in a real time, that are relevant for the servotong control unit, by storing the data in defined, storage cells of the storage component, accessible for the servotong control.

In a further embodiment, the data exchange is performed between the welding process control and the servotong control through a fast parallel bus. A fast parallel data bus is advantageous when the data quantities to be exchanged are especially great and the shared memory also has a parallel bus structure.

In accordance with another advantageous embodiment of the invention, the servotong control is programmed directly via the welding process control. The integration on the control plane of both functions allows an accurate control of the servotong movement and of the welding current level, which leads to an increase of the process quality.

The novel features which are considered as characteristic for the present invention are set forth in particular in the appended claims. The invention itself, however, both as to its construction and its method of operation, together with additional objects and advantages thereof, will be best understood from the following description of specific embodiments when read in connection with the accompanying drawings.

### BRIEF DESCRIPTION OF THE DRAWINGS

The single FIGURE of the drawings is a view showing a resistance welding system in accordance with the present invention.

### DESCRIPTION OF THE PREFERRED EMBODIMENT

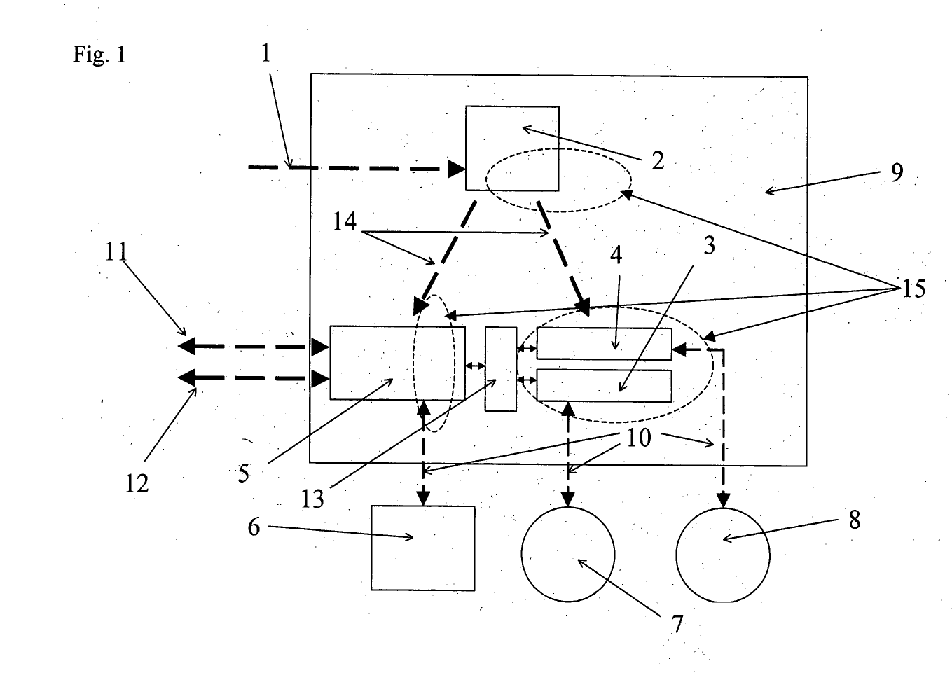

FIG. 1 shows an inventive resistance welding system which is identified as a whole with reference numeral 9. The inventive welding system has a central power unit 2, a welding control 5, two drive units 3 and 4, and associated servomotors 4 and 8. A welding transformer 6 controls the welding control 5, which in accordance with the present invention through a shared memory 13 communicates with the two drive units 3 and 4. These drive units are the drive units which serve for position, speed and current regulation of the servomotors and is associated power electronics.

The welding control is connected directly through a communication interface 11 with a robot control, which is designed to control the welding process and the tongs movement. The robot control and the welding control as a rule are formed as separate units, since they come from different manufacturers. The welding control 5 and the drive units 3 and 4 are supplied via the power unit 2 with energy, and also with a stabile, regulated logic voltage. The welding control 5 includes a power electronics for generation and a control unit for regulation of the welding current.

The drive units 3 and 4 include each a dc-ac convertor for controlling the motor current. Conventionally, the drive units 3 and 4 are also supplied with a position feedback or other relevant measuring signals from the motors 7 and 8.

The power unit 2 supplies, through a common intermediate circular bus 14, both the welding control unit 5 and the drive units 3 and 4, which subsequently control the servomotors 7 and 8. Thereby sensitive, large and expensive components, such as electrolyte capacitors and throttles are dispensed with. The inventive construction results in a minimization of a structural volume and an increase of the service life of the welding system 9. A minimization of the structural volume has also the advantage that the welding system 9 does not require an expensive space in the switching cabinet, or can be mounted directly in the housing of a robot.

Energy recovery by a back supply of the movement energy of the servomotors is always guaranteed because of the common intermediate circular bus. Braking or moving energy of the servomotors can be consumed directly by the welding process. This leads to a reduction of the required dimension capacity of the braking resistor.

The servotong is mounted for example on an arm of a robot, that is controlled by a robot-or kinematic control. The robot control is programmed to move the welding tong to a defined location. The welding control 5 during the movement can compute the data relevant for the next welding point and correspondingly generate the first position nominal value of the individual welding tong-drive units 3 and 4 and store the same in the shared memory 13. When the servotong or the robot arm reach the target position, the welding control 5 is informed by the robot control through the interface 11. Thereby the welding process can be started immediately. When the welding process ends, the robot control is informed from the welding control and moved to the next welding point.

In the inventive resistance welding system 9, during the welding process the condition of the welding point is monitored continuously by technical measurements. Based on these measurements, the welding process is controlled in a real time. The measuring system which is required for this is a component of a closed regulating circuit, whose band width and stability is independent from the dead times available in the system. For this reason, the optimization of the data communication between the system components with higher significance, and the inventive integration of the important components is advantageous.

The received measuring data are processed in the welding control 5 during the welding, and new position nominal values for the drive units 3 and 4 are generated and stored in the shared memory 13. The nominal values are read by the drive units from the shared memory, and the required movements of the servomotors are carried out. This loop is repeated in a millisecond cycle, until the process of the welding control is finished.

It will be understood that each of the elements described above, or two or more together, may also find a useful application in other types of constructions differing from the types described above.

While the invention has been illustrated and described as embodied in a resistance welding system, it is not intended to be limited to the details shown, since various modifications and structural changes may be made without departing in any way from the spirit of the present invention.

Without further analysis, the foregoing will so fully reveal the gist of the present invention that others can, by applying current knowledge, readily adapt it for various applications without omitting features that, from the standpoint of prior art, fairly constitute essential characteristics of the generic or specific aspects of this invention.

1. An apparatus for resistance welding with a welding system, comprising an energy supply system; a welding convertor; a welding process control; a servowelding tong; a servotong control; said welding convertor, said welding process control, said energy supply system and said servotong control forming a structural unit.

2. An apparatus as defined in claim 1, wherein said energy supply system of said welding convertor is formed so that it is also used for supplying electrical energy to said servotong control.

3. An apparatus as defined in claim 1, wherein said energy supply system of a logic circuit of said welding convertor is formed so that it is also used for energy supply of a control of said servotong control and said welding process control.

4. An apparatus as defined in claim 3; and further comprising a cooling system provided for cooling of said welding convertor and is formed so that it is also used for cooling of said servotong control.

5. An apparatus as defined in claim 4; and further comprising means for data exchange between said servotong control and said welding process control, said data exchange means including a shared memory.

6. An apparatus as defined in claim 1; and further comprising means for a data exchange between said servotong control and said welding process control and including a parallel data bus.

7. An apparatus as defined in claim 1, wherein said welding process control is formed so that it provides a programming of said servotong control.
